(19) United States
(12) Patent Application Publication
(10) Pub. No.: US 2019/0205877 A1
(43) Pub. Date: Jul. 4, 2019

(54) METHOD OF DIGITAL ASSET TRANSACTION

(71) Applicant: CoolBitX Ltd., Grand Cayman (KY)

(72) Inventors: Jay ZHUANG, Taipei City (TW); Shih Mai OU, Taipei City (TW)

(73) Assignee: CoolBitX Ltd., Grand Cayman (KY)

(21) Appl. No.: 15/861,642

(22) Filed: Jan. 3, 2018

(51) Int. Cl. G06Q 20/40; G06Q 20/38

(52) U.S. Cl. CPC G06Q 20/401; H04L 2209/56; G06Q 20/3829; G06Q 20/407

(57) ABSTRACT

A digital asset transaction method includes the steps of generating sale and purchase information in a seller and a buyer electronic device, respectively; matching the sale and the purchase information via a transaction server to generate matched information to the seller electronic device; transmitting private key information and the matched information from the seller electronic device to a digital accounting platform for directly transmitting a digital asset from a seller digital asset account to a buyer digital asset account; and, after verifying the transmission of digital asset, the transaction server transferring an amount of transaction currency from a buyer currency account to a seller currency account. Therefore, the digital asset is not transferred via the transaction server but directly transferred from one to another digital asset account once the digital accounting platform receives the private key information and the matched information. Therefore, the risk of digital asset theft is reduced.

### FIELD OF THE INVENTION

The present invention relates to a method of digital asset transaction, and more particularly, to a digital asset transaction method, according to which digital asset is directly transferred from a seller digital asset account to a buyer digital asset account on a digital accounting platform instead of via a transaction server to reduce the risk of digital asset theft.

### BACKGROUND OF THE INVENTION

For consumers to take the public transit or go shopping or consume at different stores without the need of carrying cash with them, making a transaction using a digital asset has gradually become an unavoidable trend in the modern society. Some of the currently very common E-transaction devices that use digital assets, such as E-money, include electronic wallet, credit card, prepaid card, Easy Card, etc.

When a consumer purchases a digital asset to recharge an E-transaction device, the purchased digital asset is stored in a transaction server connected to a network while a piece of amount information of a total balance of the digital asset is stored in the E-transaction device. When the consumer uses the E-transaction device to make a consumptive transaction, the E-transaction device can be connected to the transaction server via a card reader and a corresponding network, such as the Internet, so that a corresponding amount of the digital asset is transferred at the transaction server, and the amount information is updated accordingly to show the new total balance of the digital asset stored in the E-transaction device.

Since the digital asset is stored on the transaction server and the transaction server is continuously connected to the Internet, some malicious persons, such as hackers, might use any defect in the digital asset security protection device, such as a firewall, to steal the digital asset from the transaction server and accordingly, cause financial loss to the consumers.

### SUMMARY OF THE INVENTION

A primary object of the present invention is to provide a method of digital asset transaction, according to which digital asset is not stored on a transaction server connected to the Internet and accordingly, is not transferred via the transaction server in a digital asset transaction. With the digital asset transaction method of the present invention, it is able to avoid malicious digital asset theft at the transaction server and accordingly upgrade the security in digital asset transaction.

To achieve the above and other objects, the method of digital asset transaction according to a preferred embodiment the present invention includes the following steps: First, create a seller currency account and a buyer currency account on a transaction matching platform, and create a seller digital asset account and a buyer digital asset account on a digital accounting platform. The seller digital asset account has a seller digital asset and a piece of seller open information stored therein, and the seller open information shows a total balance of the seller digital asset.

Second, store a piece of seller private key information in a seller closed storage device for authorizing a transfer of the seller digital asset; connect the seller closed storage device to a seller electronic device for the seller electronic device to generate a piece of sale information of selling the seller digital asset and transmit the sale information to a transaction server that is connected to the transaction matching platform and the digital accounting platform; and the transaction server generates a piece of seller transaction information based on the sale information, the seller open information, the seller digital asset account and the seller currency account. A buyer electronic device generates a piece of purchase information of buying the seller digital asset and transmits the purchase information to the transaction server; and the transaction server generates a piece of buyer transaction information based on the purchase information, the buyer digital account and the buyer currency account.

The digital asset transaction method according to the preferred embodiment of the present invention further includes the following steps before the step of generating the seller transaction information: The transaction server verifies whether or not a sale limit shown in the sale information is smaller than or equal to the total balance of the seller digital asset shown in the seller open information; the transaction server generates the seller transaction information when the sale limit shown in the sale information is smaller than or equal to the total balance of the seller digital asset shown in the seller open information; and the transaction server does not generate any seller transaction information when the sale limit shown in the sale information is larger than the total balance of the seller digital asset shown in the seller open information.

The digital asset transaction method according to the preferred embodiment of the present invention further includes the following steps before the step of generating the buyer transaction information: The transaction server verifies whether or not a purchase limit shown in the purchase information is smaller than or equal to a currency total balance in the buyer currency account; the transaction server generates the buyer transaction information when the purchase limit shown in the purchase information is smaller than or equal to the currency total balance in the buyer currency account; and the transaction server does not generate any buyer transaction information when the purchase limit shown in the purchase information is larger than the currency total balance in the buyer currency account.

The method of digital asset transaction further includes the following steps: The transaction server compares the seller transaction information with the buyer transaction information to generate at least one piece of matched information and transmits the matched information to the seller electronic device. The seller closed storage device generates a piece of signature information via the seller private key information and transmits the signature information to the seller electronic device. And, the seller electronic device generates a piece of asset transfer information according to the matched information and transmits the signature information and the asset transfer information to the digital accounting platform, so that the digital accounting platform directly transfers the seller digital asset to the buyer digital asset account.

Finally, the transaction server verifies that the seller digital asset has been transferred to the buyer digital asset account and then transfers a corresponding amount of transaction currency from the buyer currency account to the seller currency account. According to the preferred embodiment of the present invention, the matched information includes the seller transaction information and the buyer transaction information.

According to the preferred embodiment of the present invention, after the step of transferring the seller digital asset from the seller digital asset account to the buyer digital asset account according to the asset transfer information, the following step is further performed: the transaction server verifies the transfer of the seller digital asset to the buyer digital asset account according to the asset transfer information.

The method of digital asset transaction according to the present invention is characterized in that, when the seller confirms to make the transaction, the seller electronic device will transmit the matched information and the seller private key information to the digital accounting platform, so that the digital asset stored in the seller digital asset account is directly transferred to the buyer digital asset account at the digital account platform. That is, the digital asset will not be transmitted to the transaction server in the process of the digital asset transaction and it is therefore able to eliminate the risk of malicious digital asset theft from the transaction server.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a flowchart showing the steps included in a method of digital asset transaction according to a first preferred embodiment of the present invention;

FIG. 2 is a modular view of a digital asset transaction system via which the method of digital asset transaction according to the present invention is implemented;

FIG. 3 is a pictorial view of the preparation step S1 shown in FIG. 1;

FIG. 4 is a pictorial view of the matching step S2 shown in FIG. 1;

FIG. 5 is a pictorial view of the confirmation step S3 shown in FIG. 1;

FIG. 6 is a pictorial view of the transaction preparation step S4 shown in FIG. 1;

FIG. 7 is a pictorial view of the transaction step S5 shown in FIG. 1;

FIG. 8 is a pictorial view of the transaction cancellation step S6 shown in FIG. 1; and

FIG. 9 is a flowchart showing the steps included in a method of digital asset transaction according to a second preferred embodiment of the present invention.

### DETAILED DESCRIPTION OF THE PREFERRED EMBODIMENTS

The present invention will now be described with some preferred embodiments thereof and by referring to the accompanying drawings. For the purpose of easy to understand, elements that are the same in the preferred embodiments are denoted by the same reference numerals.

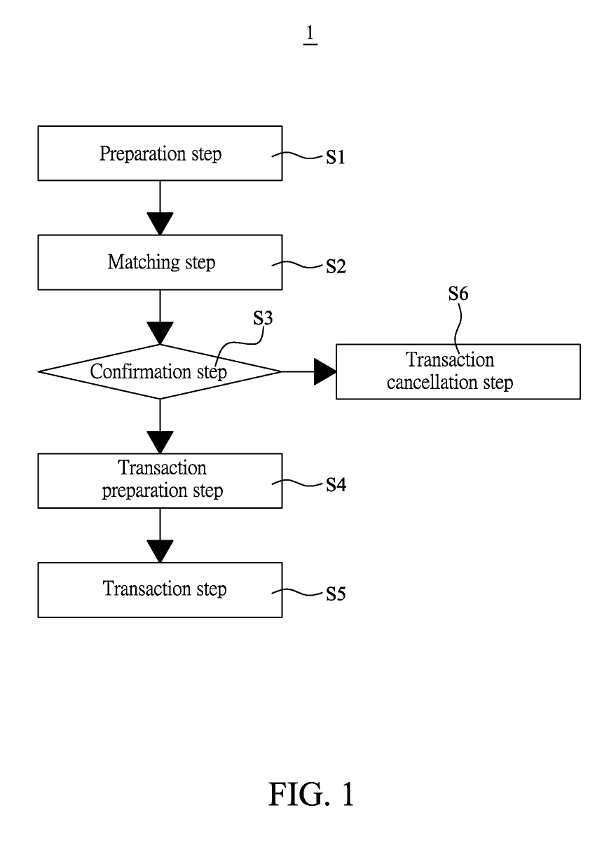

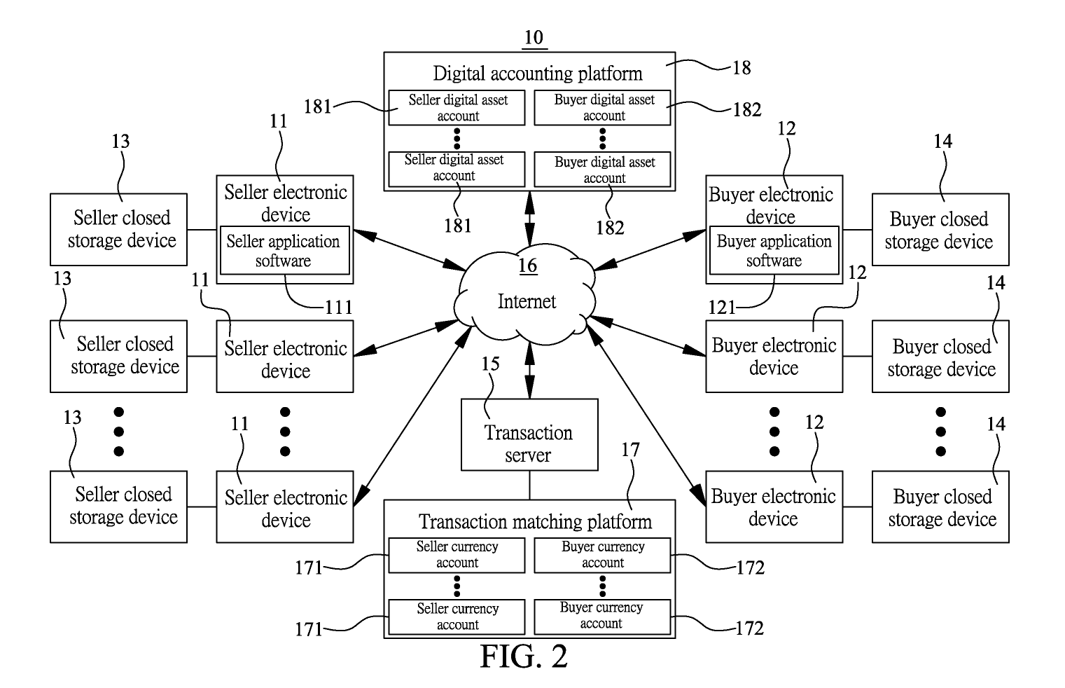

Please refer to FIG. 1, which is a flowchart showing the steps included in a method of digital asset transaction 1 according to a first preferred embodiment of the present invention, and to FIG. 2, which is a modular view of a digital asset transaction system 10 via which the method of digital asset transaction 1 according to the present invention is implemented. As shown, the digital asset transaction system 10 includes a plurality of seller electronic devices 11, a plurality of buyer electronic devices 12, a plurality of seller closed storage devices 13, a plurality of buyer closed storage devices 14, and a transaction server 15.

Each of the seller electronic devices 11 has a piece of seller application software 111 installed thereon, and each of the buyer electronic devices 12 has a piece of buyer application software 121 installed thereon. All the seller and the buyer electronic devices 11, 12 are automatically connectable to the Internet 16, which is also connected to the transaction server 15, so that all the seller and the buyer electronic devices 11, 12 can be connected to the transaction server 15 via the Internet 16. However, it is noted the seller application software 111 is not connected to the buyer application software 121, i.e. the seller application software 111 and the buyer application software 121 are in a mutually disconnected state. Herein, the seller and the buyer electronic devices 11, 12 can be mobile phones, computers or tablet computers.

All the seller closed storage devices 13 are not automatically connectable to the Internet 16, but can be respectively selectively connected to or disconnected from the seller application software 111 in one of the seller electronic devices 11 in a one-to-one correspondence. The seller closed storage devices 13 respectively have a piece of seller open information and a piece of seller private key information stored thereon. When any of the seller closed storage devices 13 is connected to its corresponding seller application software 111, the seller closed storage device 13 can be connected to the Internet 16 via the seller electronic device 11 having the corresponding seller application software 111 installed thereon.

All the buyer closed storage devices 14 are not automatically connectable to the Internet 16, but can be respectively selectively connected to or disconnected from the buyer application software 121 in one of the buyer electronic devices 12 in a one-to-one correspondence. The buyer closed storage devices 14 respectively have a piece of buyer open information and a piece of buyer private key information stored thereon. When any of the buyer closed storage devices 14 is connected to its corresponding buyer application software 121, the buyer closed storage device 14 can be connected to the Internet 16 via the buyer electronic device 12 having the corresponding buyer application software 121 installed thereon. In the illustrated first preferred embodiment of the present invention, the seller and the buyer closed storage devices 13, 14 can be respectively an electronic card with a security chip.

In the illustrated first preferred embodiment, whenever seller digital asset and buyer digital asset are referred to, they can be an electronic currency or any valuable digitized item. As shown in FIG. 2, the transaction server 15 is connected to a transaction matching platform 17, which has a plurality of seller currency accounts 171 and a plurality of buyer currency accounts 172 created thereon. The seller currency accounts 171 are in a one-to-one correspondence to the seller closed storage devices 13, and the buyer currency accounts 172 are in a one-to-one correspondence to the buyer closed storage devices 14. Further, the seller currency accounts 171 and the buyer currency accounts 172 all have transaction currencies stored therein for use.

The Internet 16 is also connected to a digital accounting platform 18, which has a plurality of seller digital asset accounts 181 and a plurality of buyer digital asset accounts 182 created thereon. The seller digital accounts 181 are in a one-to-one correspondence to the seller closed storage devices 13, and each of the seller digital asset accounts 181 has a seller digital asset and the above-mentioned seller open information stored therein. Also, the buyer digital accounts 182 are in a one-to-one correspondence to the buyer closed storage devices 14, and each of the buyer digital asset accounts 182 has a buyer digital asset and the above-mentioned buyer open information stored therein.

In the illustrated first preferred embodiment, the seller open information stored on each of the seller closed storage devices 13 is information that is accessible by anyone and shows a total balance of the seller digital asset. Therefore, a seller can have an idea about the total balance of the seller digital asset directly from the seller open information displayed on the seller closed storage device 13. That is, the seller can obtain the seller open information without the need of connecting the seller electronic device 11 to the digital accounting platform 18. On the other hand, the seller private key information stored on each of the seller closed storage devices 13 is information not accessible by anyone and is used for transferring the seller digital asset.

The buyer open information stored on each of the buyer closed storage devices 14 is information that is accessible by anyone and shows a total balance of the buyer digital asset. Therefore, a buyer can have an idea about the total balance of the buyer digital asset directly from the buyer open information displayed on the buyer closed storage device 14. That is, the buyer can obtain the buyer open information without the need of connecting the buyer electronic device 12 to the digital accounting platform 18. On the other hand, the buyer private key information stored on each of the buyer closed storage devices 14 is information not accessible by anyone and is used for transferring the buyer digital asset.

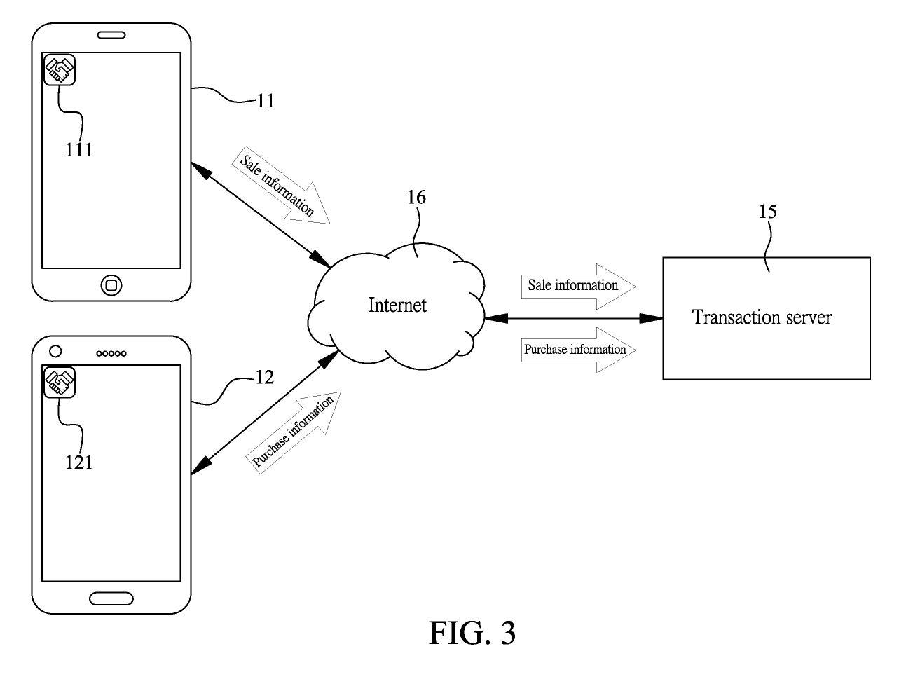

Please refer to FIGS. 1 and 3 at the same time. Each of the seller closed storage devices 13 is connected to the seller application software 111 in a one-to-one correspondence, and each of the seller electronic devices 11 is connected to the transaction server 15 via the Internet 16 for the seller application software 111 on the seller electronic device 11 to connect to the transaction server 15. Therefore, the seller closed storage device 13, the corresponding seller application software 111 and the transaction server 15 can be in a state of being connected to one another. Then, each of the seller application software 111 can generate a piece of sale information of selling a seller digital asset and transmits the sale information to the transaction server 15. From the sale information, the seller open information, the seller currency account 171 and the seller digital asset account 181, the transaction server 15 generates a piece of seller transaction information. Wherein, the aforesaid sale information shows a sale limit for the seller digital asset to be sold.

Each of the buyer closed storage devices 14 is connected to the buyer application software 121 in a one-to-one correspondence, and each of the buyer electronic devices 12 is connected to the transaction server 15 via the Internet 16 for the buyer application software 121 on the buyer electronic device 12 to connect to the transaction server 15. Therefore, the buyer closed storage device 14, the corresponding buyer application software 121 and the transaction server 15 can be in a state of being connected to one another. Then, each of the buyer application software 121 can generate a piece of purchase information of buying a seller digital asset and transmits the purchase information to the transaction server 15. From the purchase information, the buyer currency account 172 and the buyer digital asset account 182, the transaction server 15 generates a piece of buyer transaction information. Wherein, when the transaction server 15 generates the aforesaid seller transaction information and the buyer transaction information, a preparation step S1 for the digital asset transaction is completed. In the illustrated first preferred embodiment, the aforesaid purchase information shows a purchase limit for buying the seller digital asset to be sold.

In the illustrated first preferred embodiment, the transaction server 15 will first verify whether the sale limit in the sale information is smaller than or equal to the digital asset total balance in the seller open information. If yes, the transaction server 15 generates the seller transaction information. On the other hand, when the transaction server 15 finds the sale limit in the sale information is larger than the digital asset total balance in the seller open information, the transaction server will not generate the seller transaction information.

The transaction server 15 will also first verify whether the purchase limit in the purchase information is smaller than or equal to a currency total balance in the buyer currency account 172. If yes, the transaction server 15 generates the buyer transaction information. On the other hand, when the transaction server 15 finds the purchase limit in the purchase information is larger than the currency total balance in the buyer currency account 172, the transaction server will not generate the buyer transaction information.

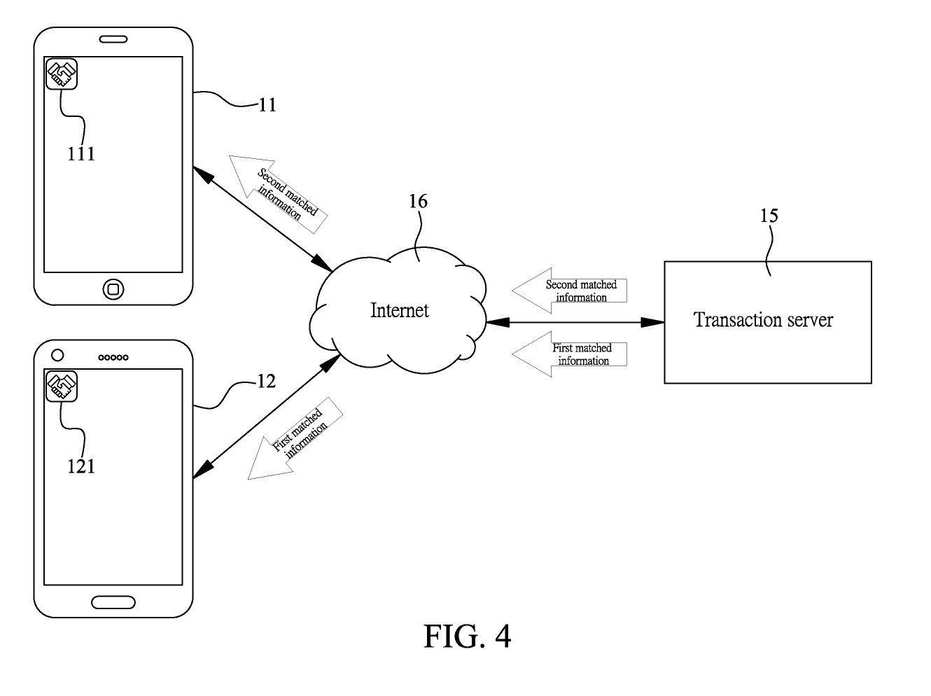

Please refer to FIGS. 1 and 4 at the same time. After completion of the preparation step S1, a matching step S2 follows. In the matching step S2, the transaction server 15 will compare every piece of seller transaction information with every piece of buyer transaction information. When the transaction server 15 finds any one of the seller transaction information matches one of the buyer transaction information, the transaction server 15 will generate a piece of first matched information and a piece of second matched information, both of which include the aforesaid matched seller transaction information and buyer transaction information. And, the transaction server 15 will transmit the first matched information to the corresponding buyer application software 121 and transmits the second matched information to the corresponding seller application software 111.

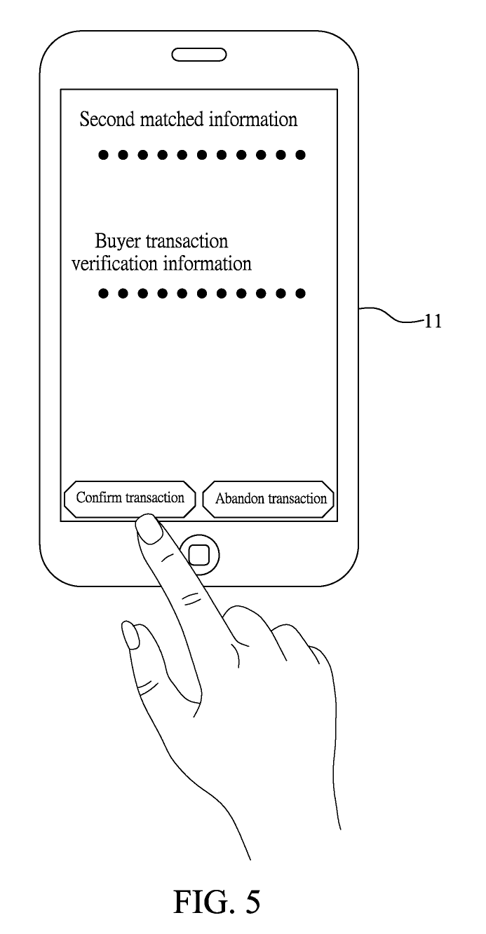

Please refer to FIGS. 1 and 5 at the same time. When the second matched information is received by the corresponding seller application software 111, the buyer transaction information, including the purchase information, the buyer currency account 172 and the buyer digital asset account 182, as well as the seller transaction information, including the sale information, the seller open information about the seller digital asset, the seller currency account 171 and the seller digital asset account 181, that are included in the second matched information will be displayed on the corresponding seller electronic device 11. Similarly, when the first matched information is received by the corresponding buyer application software 121, the seller transaction information, including the sale information, the seller open information about the seller digital asset, the seller currency account 171 and the seller digital asset account 181, as well as the buyer transaction information, including the purchase information, the buyer currency account 172 and the buyer digital asset account 182, that are included in the first matched information will be displayed on the corresponding buyer electronic device 12. When the buyer has viewed the seller transaction information and has the intention to buy the seller digital asset, the buyer can cause the buyer application software 121 to generate a piece of buyer transaction verification information that includes the aforesaid buyer and seller transaction information, and transmits the buyer transaction verification information to the seller application software 111 via the transaction server 15, so that the seller electronic device 11 simultaneously displays the buyer and the seller transaction information included in the second matched information as well as the buyer and the seller transaction information included in the buyer transaction verification information. When the seller wants to make the transaction and confirms the buyer and the seller transaction information in the second matched information matches the buyer and the seller transaction information in the buyer transaction verification information, the seller can push a “confirm transaction” key on the seller electronic device 11 to complete a confirmation step S3.

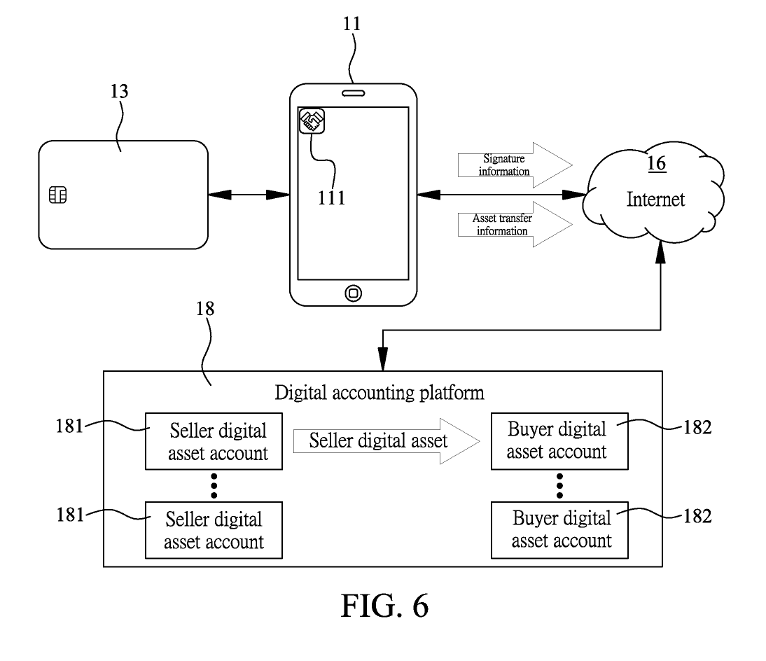

Please refer to FIGS. 1 and 6 at the same time. After completion of the confirmation step S3, a transaction preparation step S4 follows. In the transaction preparation step S4, when the seller pushes the “confirm transaction” key, the seller closed storage device 13 will generate a piece of signature information via the seller private key information and transmits the signature information to the seller electronic device 11. Meanwhile, according to the aforesaid second matched information and the buyer transaction verification information, the seller application software 111 on the seller electronic device 11 generates a piece of asset transfer information, which and the signature information are transmitted from the seller electronic device 11 to the digital accounting platform 18 via the Internet 16. When the digital accounting platform 18 receives the asset transfer information and the signature information, it first verifies the signature information and then directly transfers, according to the asset transfer information, the seller digital asset in the seller digital asset account 181 to the buyer digital asset account 182. At this point, the buyer digital asset account 182 will have both the buyer digital asset and the seller digital asset stored therein.

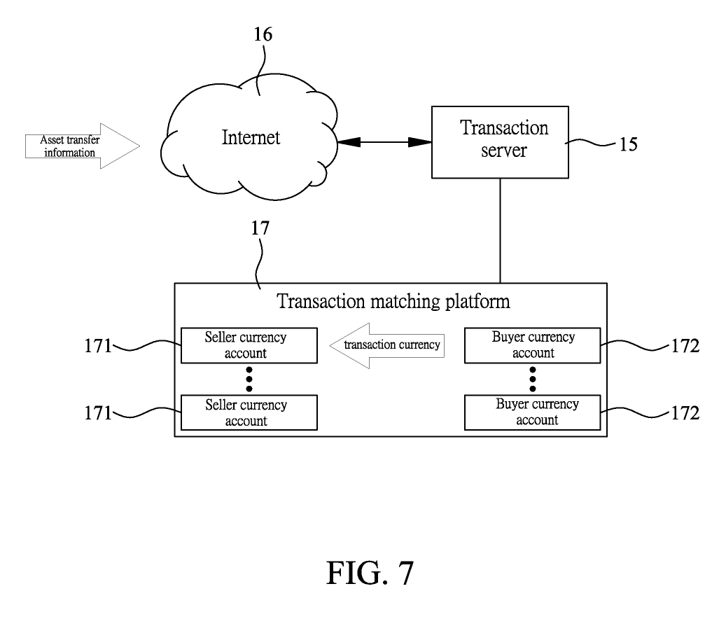

Please refer to FIGS. 1 and 7 at the same time. When the seller digital asset is transferred from the seller digital asset account 181 to the buyer digital asset account 182, the transaction server 15 will verify based on the asset transfer information that the seller digital asset has been transferred to the buyer digital asset account 182, and the transaction server 15 will then transfer a corresponding amount of the transaction currency in the buyer currency account 172 to the seller currency account 171. At this point, the transaction currency in the buyer currency account 172 is decreased while the transaction currency in the seller currency account 171 is increased, and a transaction step S5 is completed.

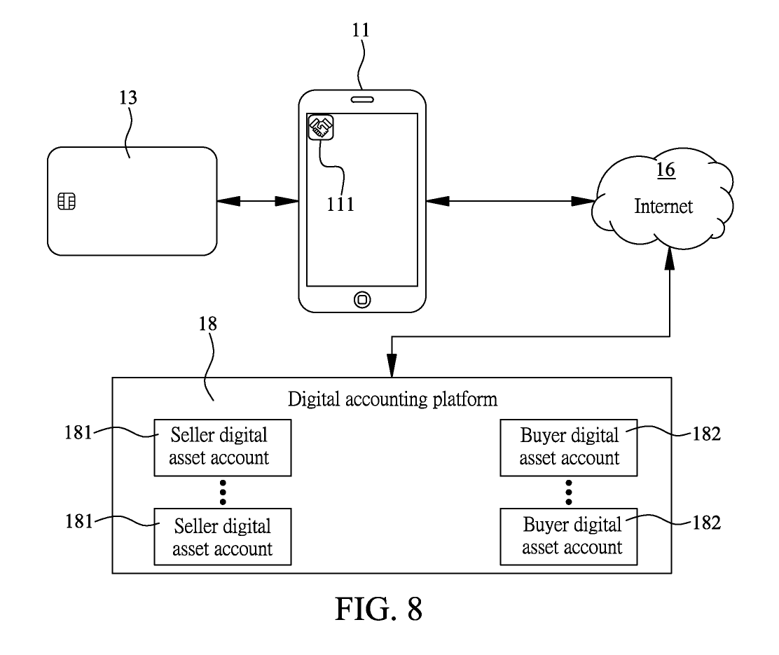

Please refer to FIGS. 1 and 8 at the same time. In the event the seller has no intention to make the transaction or the buyer and the seller transaction information in the second matched information is different from that in the buyer transaction verification information, the seller can push a “abandon transaction” key on the seller electronic device 11 (see FIG. 5) to immediately perform a transaction cancellation step S6. In this case, the seller closed storage device 13 does not generate any signature information and the seller electronic device 11 does not generate any asset transfer information. Therefore, no signature information and asset transfer information will be transmitted to the digital accounting platform 18, and no seller digital asset will be transferred to the buyer digital asset account 182.

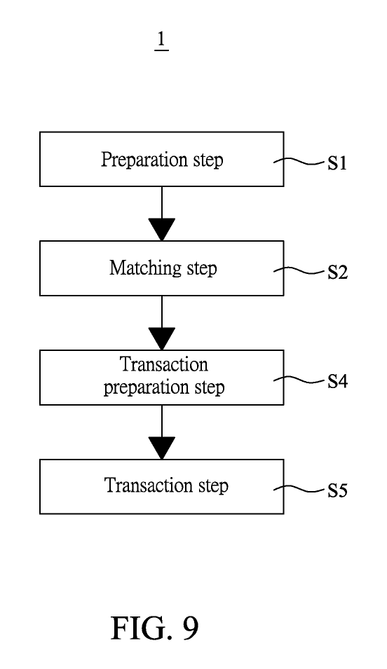

Please refer to FIG. 9 that is a flowchart showing the steps included in a method of digital asset transaction 1 according to a second preferred embodiment of the present invention. The second preferred embodiment is different from the first one in that it omits the confirmation step S3 and the transaction cancellation step S6. That is, the second preferred embodiment only includes the preparation step S1, the matching step S2, the transaction preparation step S4 and the transaction step S5. Therefore, according to the second preferred embodiment, the seller need not verify whether the buyer and the seller transaction information in the second matched information matches that in the buyer transaction verification information. In this case, when the transaction server 15 transmits the first and the second matched information to the buyer application software 121 and the seller application software 111, respectively, the seller electronic device 11 and the seller closed storage device 13 will directly generate the asset transfer information and the signature information, respectively. Further, the seller electronic device 11 will transmit the asset transfer information and the signature information to the digital accounting platform 18 via the Internet 16, so that the seller digital asset is transferred to the buyer digital asset account 182.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A method of digital asset transaction, comprising the following steps:
creating a seller currency account and a buyer currency account on a transaction matching platform, and creating a seller digital asset account and a buyer digital asset account on a digital accounting platform; the seller digital asset account having a seller digital asset and a piece of seller open information stored therein, and the seller open information showing a total balance of the seller digital asset;
storing a piece of seller private key information in a seller closed storage device for authorizing a transfer of the seller digital asset, connecting the seller closed storage device to a seller electronic device for the seller electronic device to generate a piece of sale information of selling the seller digital asset and transmit the sale information to a transaction server that is connected to the transaction matching platform and the digital accounting platform; and the transaction server generating a piece of seller transaction information based on the sale information, the seller open information, the seller digital asset account and the seller currency account;
a buyer electronic device generating a piece of purchase information of buying the seller digital asset and transmitting the purchase information to the transaction server; and the transaction server generating a piece of buyer transaction information based on the purchase information, the buyer digital account and the buyer currency account;
the transaction server comparing the seller transaction information with the buyer transaction information to generate at least one piece of matched information and transmitting the matched information to the seller electronic device;
the seller closed storage device generating a piece of signature information via the seller private key information and transmitting the signature information to the seller electronic device; and the seller electronic device generating a piece of asset transfer information according to the matched information and transmitting the signature information and the asset transfer information to the digital accounting platform, so that the digital accounting platform directly transfers the seller digital asset to the buyer digital asset account; and
the transaction server verifying that the seller digital asset has been transferred to the buyer digital asset account and then transferring a corresponding amount of transaction currency from the buyer currency account to the seller currency account.

2. The method of digital asset transaction as claimed in claim 1, further comprising the following step after the step of transferring the seller digital asset from the seller digital asset account to the buyer digital asset account according to the asset transfer information: the transaction server verifying the transfer of the seller digital asset to the buyer digital asset account according to the asset transfer information.

3. The method of digital asset transaction as claimed in claim 1, further comprising the following steps before the step of generating the seller transaction information:
the transaction server verifying whether or not a sale limit shown in the sale information is smaller than or equal to the total balance of the seller digital asset shown in the seller open information;
the transaction server generating the seller transaction information when the sale limit shown in the sale information is smaller than or equal to the total balance of the seller digital asset shown in the seller open information; and
no seller transaction information being generated by the transaction server when the sale limit shown in the sale information is larger than the total balance of the seller digital asset shown in the seller open information.

4. The method of digital asset transaction as claimed in claim 1, further comprising the following steps before the step of generating the buyer transaction information:
the transaction server verifying whether or not a purchase limit shown in the purchase information is smaller than or equal to a currency total balance in the buyer currency account;
the transaction server generating the buyer transaction information when the purchase limit shown in the purchase information is smaller than or equal to the currency total balance in the buyer currency account; and
no buyer transaction information being generated by the transaction server when the purchase limit shown in the purchase information is larger than the currency total balance in the buyer currency account.
